(19) United States
(12) Patent Application Publication
(10) Pub. No.: US 2012/0125895 A1
(43) Pub. Date: May 24, 2012

(54) WIRE TRANSMITTING MODULE

(75) Inventors: SHAO-KU HUANG, Taichung City (TW); Tzuo-Liang Luo, Hsinchu City (TW); Yi-Ming Chen, Taichung City (TW)

(73) Assignee: Industrial Technology Research Institute, Hsinchu (TW)

(21) Appl. No.: 13/096,242

(22) Filed: Apr. 28, 2011

(30) Foreign Application Priority Data
Nov. 23, 2010 (TW) 099140367

(51) Int. Cl. B23H 1/04

(52) U.S. Cl. 219/69.15

(57) ABSTRACT

A wire transmitting module, disposed inside a Wire Electrical Discharge Machining (WEDM) apparatus having a roller set for providing a wire electrode, is disclosed, which comprises: a negative pressure generating device and a cylinder, being arranged for enabling the wire electrode to be drawn by the negative pressure of the negative pressure generating device so as to be sucked into the wire transmitting module automatically. When the diameter of the wire electrode is thinner than 0.1 mm, it may be too soft to be fed into the cylinder manually as it can easily be affected by airflow or static. Thus, by using the wire transmitting module for enabling the wire electrode to be sucked by the negative pressure and thus being fed into the cylinder, the electrode feeding efficiency can be greatly improved.

### FIELD OF THE DISCLOSURE

The present disclosure relates to a suctorial transmission cylinder, and more particularly, to a wire transmitting module capable of using a negative pressure generating device disposed therein for sucking and thus drawing a wire electrode to move automatically.

### BACKGROUND OF THE DISCLOSURE

Electrical discharge machining (EDM) is a specialized thermal machining process capable of accurately machining parts of hard materials with complex shapes, by which materials from the work piece are eroded by a series of discrete sparks between the work and tool electrode immersed in a liquid dielectric medium. These electrical discharges melt and vaporize minute amounts of the work material, which are then ejected and flushed away by the dielectric. At the same time, by the craters formed on the workpiece due to the EDM, the workpiece could be processed into any shape as required.

Technology of the Wire Electrical Discharge Machining (WEDM) process is based on the conventional EDM sparking phenomenon utilizing the widely accepted noncontact technique of material removal with a difference that spark is generated at wire and work piece gap. In WEDM, a thin single-strand metal wire, usually brass, being fed through the workpiece while submerging in a tank of dielectric fluid, is enabled to work somewhat like a jib saw, except for the kerf is created by a series of electrical discharging for removing tiny particles of the workpiece. Because the WEDM does not require high cutting forces for removal of material, and also it is free from detrimental effect of the wear on tool electrode as the wire electrode used in the WEDM is constantly fed from a spool, WEDM has proved to be one of the best options for micro processing. WEDM works with materials that are electrically conductive, regardless how hard the materials are, and with machining precision.

Since the diameters of wire electrodes that are most commonly used in WEDM nowadays are larger than 0.1 mm, the threading of such wire electrodes into the guide pipe for WEDM can be performed easily by hand. However, for those wire electrodes whose diameters are smaller than 0.1 mm, such as those with 0.05 mm wire diameter and 0.02 wire diameter, the threading can be a very difficult task to handle by hand without the help of any fluid driving/guiding mechanism since those wire electrodes can be too soft and flexible, not to mention that it can easily attached itself to the guide pipe or other wire transmitting mechanisms during the threading of the wire electrode.

Recently, the aforementioned problem is addressed by providing a leading wire fluid that is flowing near a wire electrode entrance of the guide pipe so as to be used for driving the wire electrode to move with the flowing fluid while preventing the same from attaching to the internal wall of the guide pipe. Nevertheless, despite the providing of the leading wire fluid, the flowing of the leading wire fluid still could not drive the wire electrode to move therewith unless the wire electrode had been threaded through the wire electrode entrance and reached the flowing wire fluid. However, for those soft wire electrodes whose diameters are thinner than 0.1 mm, they can easily be forced away from the wire fluid flow by the pressure resulting from the flowing fluid while being fed through the wire electrode entrance. Thus, the threading of the wire electrode whose diameter is thinner than 0.1 mm by hand can be a very difficult task with high failing rate.

Therefore, it is in need of a wire transmitting module for feeding the wire electrode into the wire electrode entrance automatically without being troubled by the aforesaid shortcomings.

### SUMMARY OF THE DISCLOSURE

The present disclosure provides a wire transmitting module, adapted for a Wire Electrical Discharge Machining (WEDM) apparatus, by that a wire electrode can be fed into the wire transmitting module automatically by the suction of a negative pressure, and then, the wire electrode could move with the flowing of a first fluid in the wire transmitting module. Thereby, the probability of failing to fed any wire electrodes with smaller wire diameters can be lowered.

In an embodiment, the present disclosure provides a wire transmitting module, disposed inside a wire electrical discharge machining (WEDM) apparatus having a roller set for providing a wire electrode, which comprises: a negative pressure generating device; and a cylinder, connected to the negative pressure generating device for enabling the wire electrode to be sucked by a negative pressure generated from the negative pressure generating device so as to be drawn into the wire transmitting module automatically.

In one embodiment of the present disclosure, the negative pressure generating device is a vacuum generator. In another embodiment of the present disclosure, the negative pressure generating device further comprises: an inlet, provided for allowing a first fluid to flow into the negative pressure generating device. In addition, the inlet is configured with a tapering part, designed for enabling the negative pressure to be generated during the flowing of the first fluid into the negative pressure generating device through the inlet, and thus enabling the wire electrode to be sucked and drawn by the negative pressure into the wire transmitting module.

Moreover, the cylinder further comprises: a retractable pipe, for allowing the wire electrode to be transported therethrough and also the first fluid to flowing therethrough, whereas the retractable pipe is further connected to a piston device to be used for driving the retractable pipe to retract or extend. In addition, the cylinder further comprises: a fluid channel set, used for driving the piston device; and in one embodiment of the present disclosure, the fluid channel set is substantially a first fluid channel, being disposed at a first side of the piston device and used for driving the piston device to move according to the injecting or the extracting of a second fluid into or out of the first fluid channel. In another embodiment of the present disclosure, the fluid channel set further comprises: a first fluid channel, disposed at a first side of the piston device for allowing a second fluid to flow in and out of the same; and a second fluid channel, disposed at a second side of the piston device for allowing a third fluid to flow in and out of the same; wherein, by the flowing of the second fluid in and out of the first fluid channel and the flowing of the third fluid in and out of the second fluid channel, the piston device is being driven to move accordingly for bringing along the retractable pipe to retract or extend.

Further scope of applicability of the present application will become more apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic diagram showing a wire transmitting module according to the present disclosure.

FIG. 2A is a schematic diagram showing a negative pressure generating device according to an embodiment of the present disclosure.

FIG. 2B is a schematic diagram showing a negative pressure generating device according to another embodiment of the present disclosure.

FIG. 3A is a schematic diagram showing a portion of an operating wire electrical discharge machine whose retractable pipe is connected to its upper eye mold according to the present disclosure.

FIG. 3B is a schematic diagram showing a portion of an operating wire electrical discharge machine whose retractable pipe is detached from its upper eye mold according to the present disclosure

FIG. 4A is a schematic diagram showing how a retractable pipe is being driven to move by a fluid channel set according to an embodiment of the present disclosure.

FIG. 4B is a schematic diagram showing how a retractable pipe is being driven to move by a fluid channel set according to another embodiment of the present disclosure.

FIG. 4C is a schematic diagram showing how a retractable pipe is being driven to move by a driving device according to the present disclosure.

### DESCRIPTION OF THE EXEMPLARY EMBODIMENTS

For your esteemed members of reviewing committee to further understand and recognize the fulfilled functions and structural characteristics of the disclosure, several exemplary embodiments cooperating with detailed description are presented as the follows.

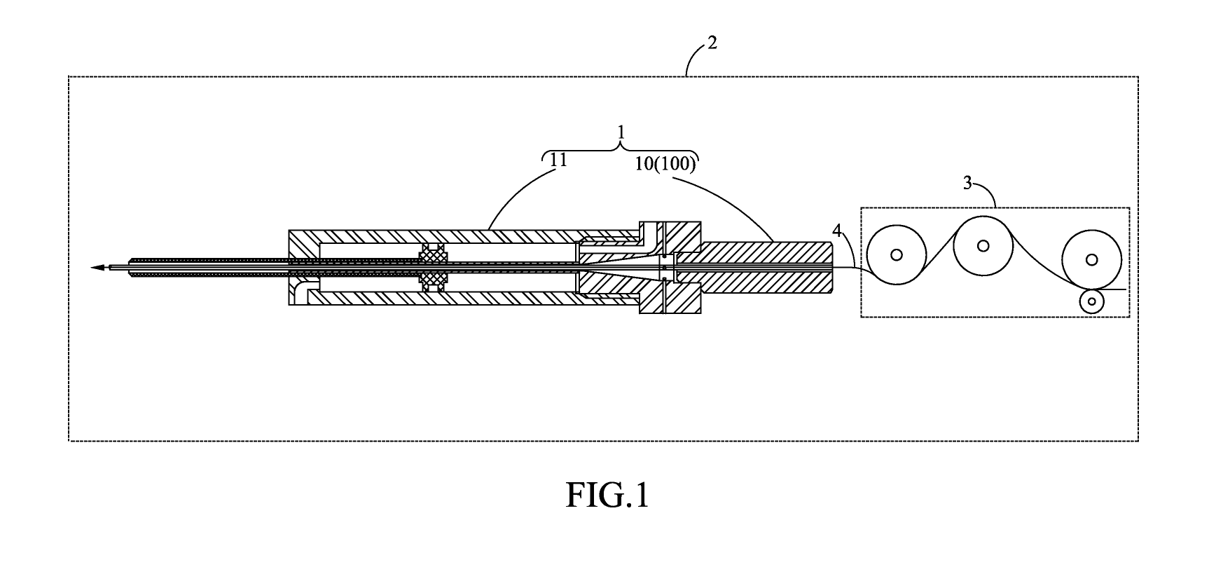

Please refer to FIG. 1, which is a schematic diagram showing a wire transmitting module according to the present disclosure. As shown in FIG. 1, a wire transmitting module 1 is disposed at a Wire Electrical Discharge Machining (WEDM) apparatus 2, whereas the WEDM apparatus 2 further comprises a roller set 3, that is used for providing a wire electrode 4. Moreover, the wire transmitting module 1 comprises: a negative pressure generating device 10; and a cylinder 11, which is connected to the negative pressure generating device 10 for enabling the wire electrode 4 to be sucked by a negative pressure generated from the negative pressure generating device 10 so as to be drawn into the wire transmitting module 1 automatically.

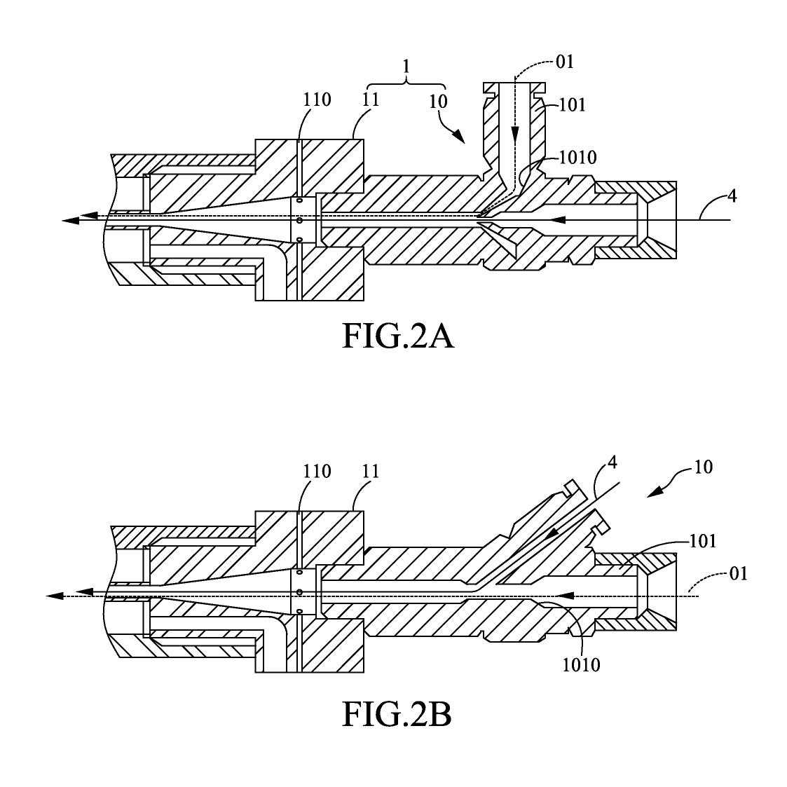

In one embodiment shown in FIG. 1, the negative pressure generating device 10 is a vacuum generator 100. On the other hand, the negative pressure generating device 10 could be constructed as the devices shown in the embodiments of FIG. 2A and FIG. 2B. As shown in FIG. 2A and FIG. 2B, the negative pressure generating device 10 is configured with an inlet 101, that is provided for allowing a first fluid 01 to flow into the negative pressure generating device 10, whereas the inlet 101 is configured with a tapering part 1010, designed for causing a Venturi-siphon effect to be resulted directly by the diameter tapering between the front and rear of tapering part 1010 in the inlet 101 so as to enable the negative pressure to be generated during the flowing of the first fluid 01 into the negative pressure generating device 10 through the inlet 101, and thus enabling the wire electrode 4 to be sucked and drawn by the negative pressure into the wire transmitting module 1. After the wire electrode 4 is sucked and drawn into the negative pressure generating device 10 by the negative pressure, it will be guided to flow along with the flowing of the first fluid 01. Moreover, in this embodiment, the cylinder 11 further comprises: a depressurization hole 110, which is designed to work in cooperation with the negative pressure generating device 10 for adjusting the pressure relating to the first fluid 01 that is flowing inside the wire transmitting module 1, that is, any excess first fluid 01 can be drained from the depressurization hole 110 and out of the wire transmitting module 1 during the feeding of the first fluid 01 into the inlet 101.

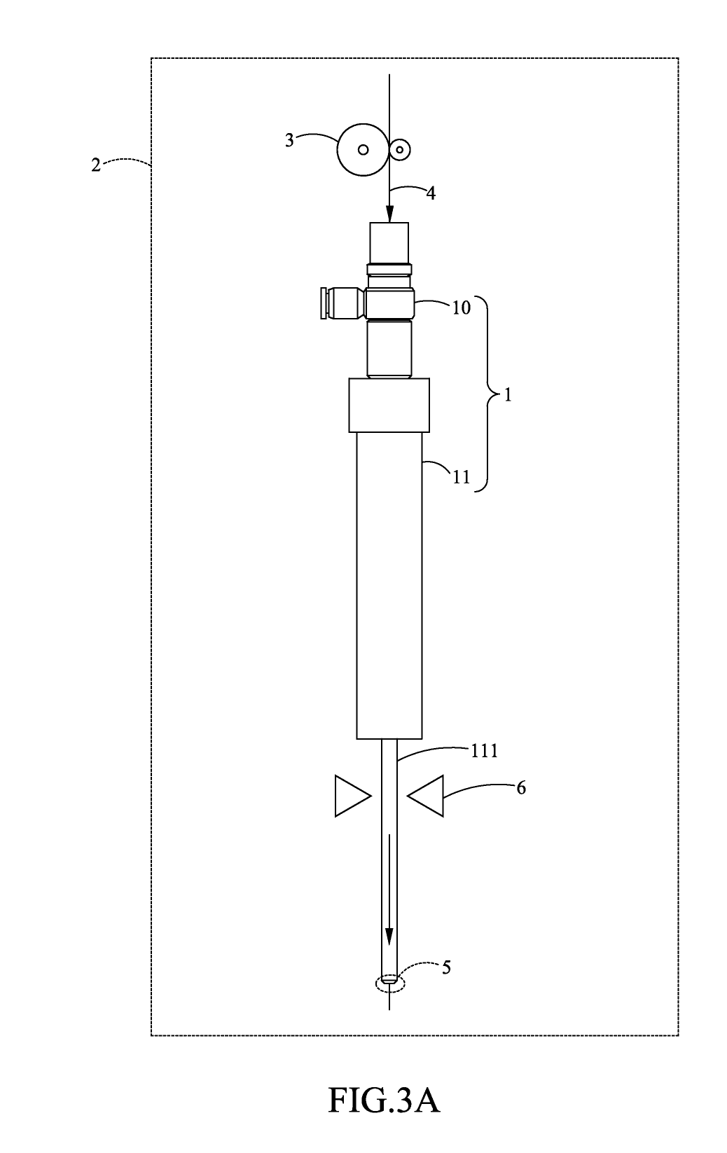

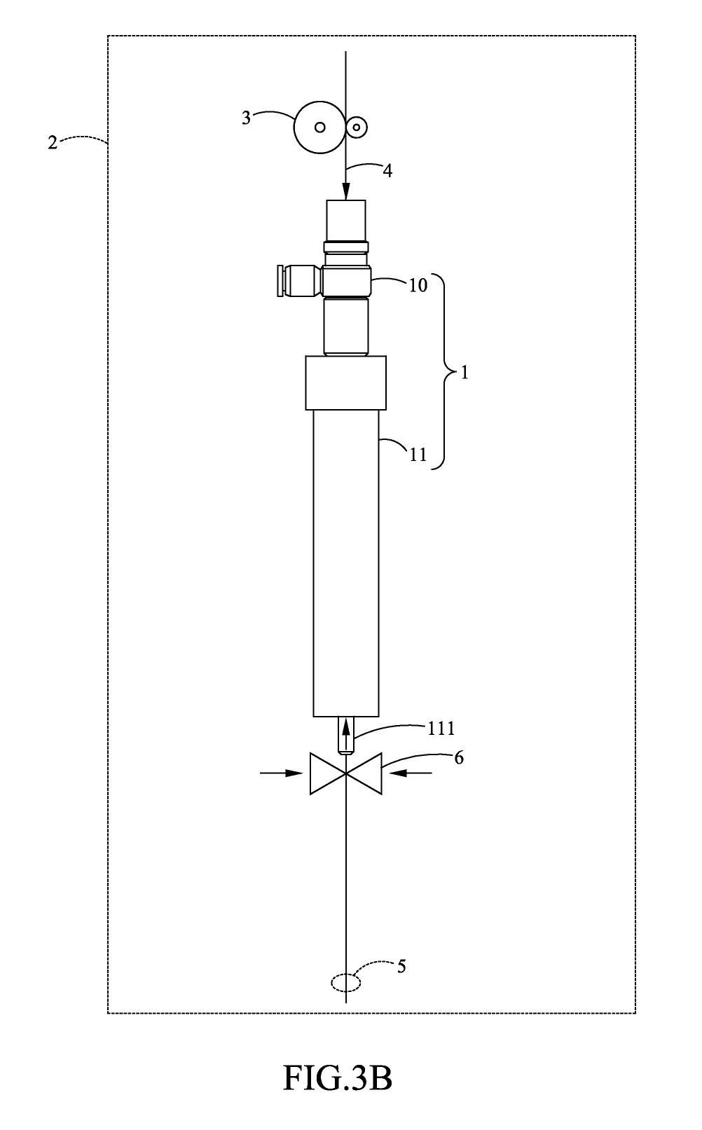

After the wire electrode 4 is sucked and drawn to the negative pressure generating device 10 by the negative pressure, the wire electrode 4 will be driven to move with the flow of the first fluid 01 toward the cylinder 11, whereas the cylinder 11 further comprises: a retractable pipe 111, as shown in FIG. 3A, which is used for allowing the wire electrode 4 to be transported therethrough and also the first fluid 01 to flowing therethrough. In addition, the retractable pipe 111 is further connected to a piston device 1110, which is used for driving the retractable pipe 111 to retract or extend. It is noted that the retractable pipe 111 that is being driven to extend is capable of connecting to an upper eye mold 5 of the WEDM apparatus 2, and thus the wire electrode 4 could be fed to the upper eye mold 5 through the extended retractable pipe 111. Please refer to FIG. 3A and FIG. 3B, which are a schematic diagram showing a portion of an operating wire electrical discharge machine whose retractable pipe is connected to its upper eye mold, and a schematic diagram showing a portion of an operating wire electrical discharge machine whose retractable pipe is detached from its upper eye mold. In FIG. 3A, the retractable pipe 111 is extended and thus connected to the upper eye mold 5 for enabling the wire electrode 4 to be fed to the upper eye mold 5. In FIG. 3B, the retractable pipe 111 is retracted and thus detached from the upper eye mold 5. As shown in FIG. 3A and FIG. 3B, the WEDM apparatus 2 is configured with a cutting device 6, which is used for cutting the wire electrode 4 when needed. It is noted that before the cutting of the wire electrode 4 is performed by the cutting device 6, the retractable pipe 111 should be retracted in advance so as to prevent the same from being damaged by the cutting of the cutting device 6.

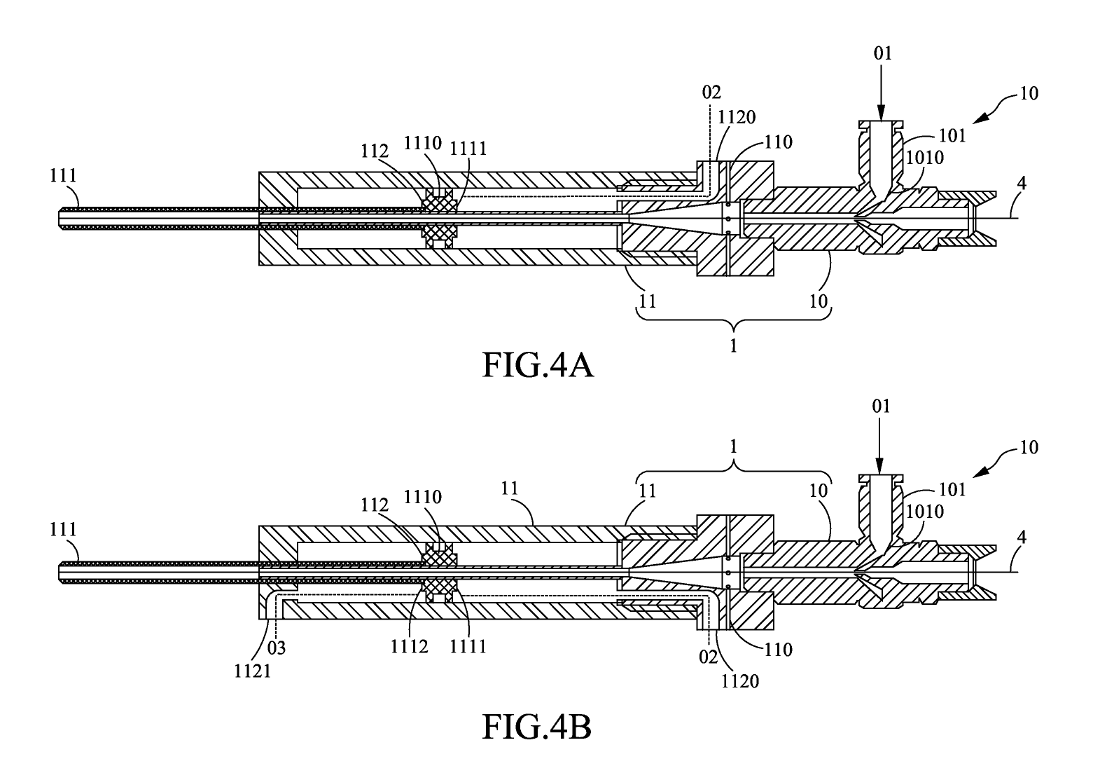

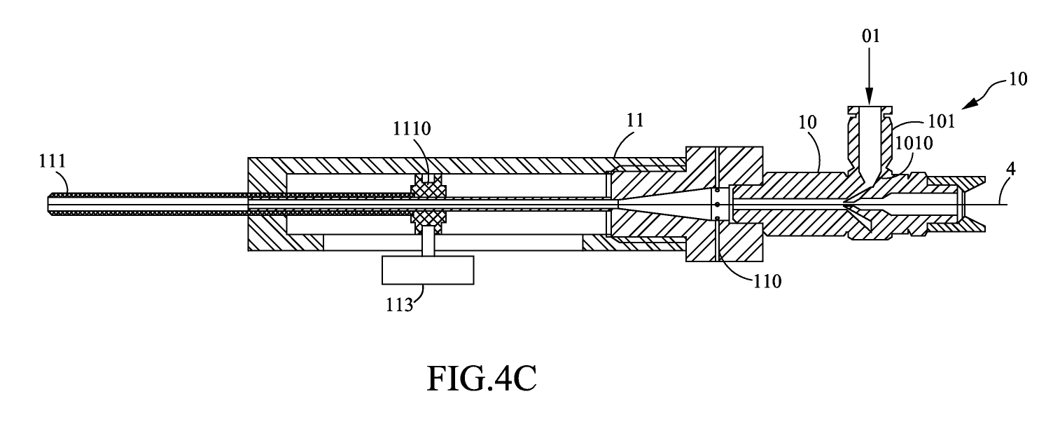

The following description relates to how the retractable pipe can be driven to extend or retract in the present disclosure. In one embodiment of the present disclosure, the cylinder 11 has a fluid channel set 112, that is used for driving the piston device 1110 to move and thus bringing along the retractable pipe 111 to extend or retract accordingly. Please refer to FIG. 4A, which is a is a schematic diagram showing how a retractable pipe is being driven to move by a fluid channel set according to an embodiment of the present disclosure. In FIG. 4A, the fluid channel set 112 is substantially a first fluid channel 1120, that is disposed at a first side 1111 of the piston device 1110 and used for driving the piston device 1110 to move according to the injecting or the extracting of a second fluid 02 into or out of the first fluid channel 1120. In another embodiment shown in FIG. 4B, the fluid channel set 112 is comprised of: a first fluid channel 1120, disposed at a first side 1111 of the piston device 1110 for allowing a second fluid 02 to flow in and out of the same; and a second fluid channel 1121, disposed at a second side 1112 of the piston device 1110 for allowing a third fluid 03 to flow in and out of the same. Moreover, by the flowing of the second fluid 02 in and out of the first fluid channel 1120 and the flowing of the third fluid 03 in and out of the second fluid channel 1121, the piston device 1110 can be driven to move accordingly and thus bring along the retractable pipe 111 to retract or extend. That is, the retractable pipe 111 is extended when the second fluid 02 is injected into the first fluid channel 1120, and the retractable pipe 111 is retracted when the third fluid 03 is injected into the second fluid channel 1121; or vice versa. In these embodiments, the first fluid 01, the second fluid 02 and the third fluid 03 could be air, but they are not limited thereby. In addition, the extending or retracting of the retractable pipe 111 could be performed using a driving device shown in FIG. 4C. In FIG. 4C, the cylinder 11 further comprises: a driving device 113, which is used for driving the retractable pipe 111 to extend or retract using a manner selected from the group consisting of: an electrical actuating manner, a magnetic actuating manner and a manual actuating manner, but is not limited thereby.

By the configuration of the negative pressure generating device 10 in the wire transmitting module 1 of the present disclosure, the process for feeding wire electrode into the wire transmitting module 1 can be simplified and the conventional difficulty for threading the wire electrode with diameter smaller than 0.1 mm can be overcome since the feeding of the wire electrode 4 into the wire transmitting module can be performed simply by placing the wire electrode 4 close to the inlet of the negative pressure generating device 10 for allowing the wire electrode 4 to be sucked naturally into the inlet by the negative pressure from the negative pressure generating device 10. Thereafter, the wire electrode 4 will be drawn to move with the flowing of the first fluid 01, so that the wire electrode 4 is prevented from being affected by static or moisture and thus attached to the inner wall of the retractable pipe 111. In addition, by the extending of the retractable pipe 111, the wire electrode 4 can be fed directly and effectively to the upper eye mold 5.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A wire transmitting module, disposed inside a Wire Electrical Discharge Machine (WEDM) having a roller set for providing a wire electrode, the wire transmitting module comprising:
a negative pressure generating device; and
a cylinder, connected to the negative pressure generating device for enabling the wire electrode to be sucked by a negative pressure generated from the negative pressure generating device so as to be drawn into the wire transmitting module automatically.

2. The wire transmitting module of claim 1, wherein the negative pressure generating device is a vacuum generator.

3. The wire transmitting module of claim 1, wherein the negative pressure generating device further comprises: an inlet, provided for allowing a first fluid to flow into the negative pressure generating device; and the inlet is configured with a tapering part, designed for enabling the negative pressure to be generated during the flowing of the first fluid into the negative pressure generating device through the inlet, and thus enabling the wire electrode to be sucked and drawn by the negative pressure into the wire transmitting module.

4. The wire transmitting module of claim 1, wherein the cylinder further comprises: a retractable pipe, for allowing the wire electrode to be transported therethrough and also the first fluid to flowing therethrough.

5. The wire transmitting module of claim 4, wherein the retractable pipe is further connected to a piston device to be used for driving the retractable pipe to retract or extend.

6. The wire transmitting module of claim 5, wherein the cylinder further comprises: a fluid channel set, used for driving the piston device.

7. The wire transmitting module of claim 6, wherein the fluid channel set is substantially a first fluid channel, being disposed at a first side of the piston device and used for driving the piston device to move according to the injecting or the extracting of a second fluid into or out of the first fluid channel.

8. The wire transmitting module of claim 6, wherein the fluid channel set further comprises: a first fluid channel, disposed at a first side of the piston device for allowing a second fluid to flow in and out of the same; and a second fluid channel, disposed at a second side of the piston device for allowing a third fluid to flow in and out of the same; and by the flowing of the second fluid in and out of the first fluid channel and the flowing of the third fluid in and out of the second fluid channel, the piston device is being driven to move accordingly for bringing along the retractable pipe to retract or extend.

9. The wire transmitting module of claim 8, wherein the third fluid is substantially the same fluid of the second fluid.

10. The wire transmitting module of claim 4, wherein the cylinder further comprises: a driving device, for driving the retractable pipe to extend or retract using a manner selected from the group consisting of: an electrical actuating manner, a magnetic actuating manner and a manual actuating manner.

11. The wire transmitting module of claim 3, wherein the cylinder further comprises: a depressurization hole, provided for allowing the first fluid to flowing out of the wire transmitting module.

12. A wire electrical discharge machine, comprising:
a roller set, used for providing a wire electrode;
a wire transmitting module, having a negative pressure generating device and a cylinder configured therein while allowing the cylinder, further including a retractable pipe, to be connected to the negative pressure generating device for enabling the wire electrode to be sucked by a negative pressure generated from the negative pressure generating device so as to be drawn into the wire transmitting module automatically; and
an upper eye mold, capable of connecting to or detaching from the retractable pipe according to the extending or retracting of the retractable pipe, while allowing the wire electrode to entering the upper eye mold when the retractable pipe is connected to the upper eye mold.

13. The wire cut electrical discharge machine of claim 12, wherein the negative pressure generating device is a vacuum generator.

14. The wire cut electrical discharge machine of claim 12, wherein the negative pressure generating device further comprises: an inlet, provided for allowing a first fluid to flow into the negative pressure generating device; and the inlet is configured with a tapering part, designed for enabling the negative pressure to be generated during the flowing of the first fluid into the negative pressure generating device through the inlet, and thus enabling the wire electrode to be sucked and drawn by the negative pressure into the wire transmitting module.

15. The wire cut electrical discharge machine of claim 12, wherein the cylinder further comprises: a depressurization hole, provided for allowing the first fluid to flowing out of the wire transmitting module.

16. The wire cut electrical discharge machine of claim 12, further comprising a cutting device, for cutting off the wire electrode.
